(19) United States
(12) Patent Application Publication
(10) Pub. No.: US 2019/0348039 A1
(43) Pub. Date: Nov. 14, 2019

(54) VOICE DETECTING METHOD AND VOICE DETECTING DEVICE

(71) Applicant: PEGATRON CORPORATION, Taipei City (TW)

(72) Inventor: NIGEL HSIUNG, TAIPEI CITY (TW)

(73) Assignee: PEGATRON CORPORATION, Taipei City (TW)

(21) Appl. No.: 16/394,991

(22) Filed: Apr. 25, 2019

(30) Foreign Application Priority Data
May 9, 2018 (TW) 107115789

(51) Int. Cl. G10L 15/22; G10L 15/26; G10L 25/78

(52) U.S. Cl. CPC G10L 15/22; G10L 15/26; G10L 2015/088; G10L 2015/223; G10L 25/78

(57) ABSTRACT

The present invention provides a voice detection method and a voice detection device. The voice detection method includes: starting recording when a keyword audio signal in a first audio signal is detected; obtaining a plurality of keyword features in the keyword audio signal; ending the recording according to the plurality of keyword features so as to obtain a second audio signal; and transmitting the keyword audio signal and the second audio signal to a voice-to-text module.

### CROSS-REFERENCE TO RELATED APPLICATION

This application claims the priority benefit of Taiwan application serial no. 107115789, filed on May 9, 2018. The entirety of the above-mentioned patent application is hereby incorporated by reference herein and made a part of this specification.

### BACKGROUND

### 1. Technology Field

The present disclosure relates to a voice detection method and a voice detection device, in particular, to a voice detection method and a voice detection device enhancing voice recognition.

### 2. Description of Related Art

Generally, existing voice detection methods are mostly that a voice detection device records a voice signal provided by a user, and the voice detection device transmits the recorded voice signal to an external voice-to-text module. The voice-to-text module judges features of the voice signal, and obtains a text message according to a comparison result of the features of the voice signal. However, a comparison basis of the features of the voice signal is provided by an external processing engine, such as a natural language processing (NLP) engine. Thus, obtaining the text message by means of the external comparison basis limits the recognition capacity of a voice instruction, which causes misjudgement for the voice signal provided by the voice detection device, making the voice detection device generate wrong service.

### SUMMARY

The present disclosure provides a voice detection method and a voice detection device for enhancing the recognition capacity of a voice instruction.

The voice detection method of the present disclosure is suitable for providing a detected voice signal to a voice-to-text module, and the voice detection method includes: starting recording when a keyword in a first audio signal is detected; obtaining a plurality of keyword features in a keyword audio signal, wherein the keyword features include an ending feature and a voice recognition feature; ending the recording according to the ending feature so as to obtain a second audio signal, and recognizing the second audio signal according to the voice recognition feature; and transmitting the keyword and the second audio signal to the voice-to-text module.

The voice detection device of the present disclosure is suitable for performing voice detection on an audio signal and is also suitable for being in communication with an external voice-to-text module. The voice detection device includes a keyword detection module, a keyword processing module and a recording module. The keyword detection module is used for detecting whether a first audio signal has a keyword audio signal or not. The keyword processing module is coupled to the keyword detection module. The keyword processing module is used for obtaining a plurality of keyword features in the keyword audio signal, wherein the keyword features include an ending feature and a voice recognition feature, and transmitting the keyword audio signal and the keyword features. The recording module is coupled to the keyword detection module and the keyword processing module. When the keyword detection module detects the keyword audio signal in the first audio signal, the recording module starts recording. The recording module receives the keyword audio signal and the keyword features. The recording module ends the recording according to the ending feature so as to obtain a second audio signal, and recognizes the second audio signal according to the voice recognition feature. The recording module transmits the keyword audio signal and the second audio signal to the voice-to-text module, thus converting the second audio signal into a text message.

Based on the above, the voice detection method and the voice detection device of the present disclosure obtain the plurality of keyword features in the keyword audio signal, end the recording according to the plurality of keyword features so as to obtain the second audio signal between recording starting and recording ending, and transmit the keyword and the second audio signal to the voice-to-text module, so as to enhance the recognition capacity of the voice instruction.

In order to make the aforementioned and other objectives and advantages of the present disclosure comprehensible, embodiments accompanied with figures are described in detail below.

### BRIEF DESCRIPTION OF THE DRAWINGS

FIG. 1 is a schematic view of a voice detection device according to an embodiment of the present invention.

FIG. 2 is a flow chart of a voice detection method according to an embodiment of the present invention.

FIG. 3 is a flow chart of the voice detection method according to step S230 of FIG. 2.

### DESCRIPTION OF THE EMBODIMENTS

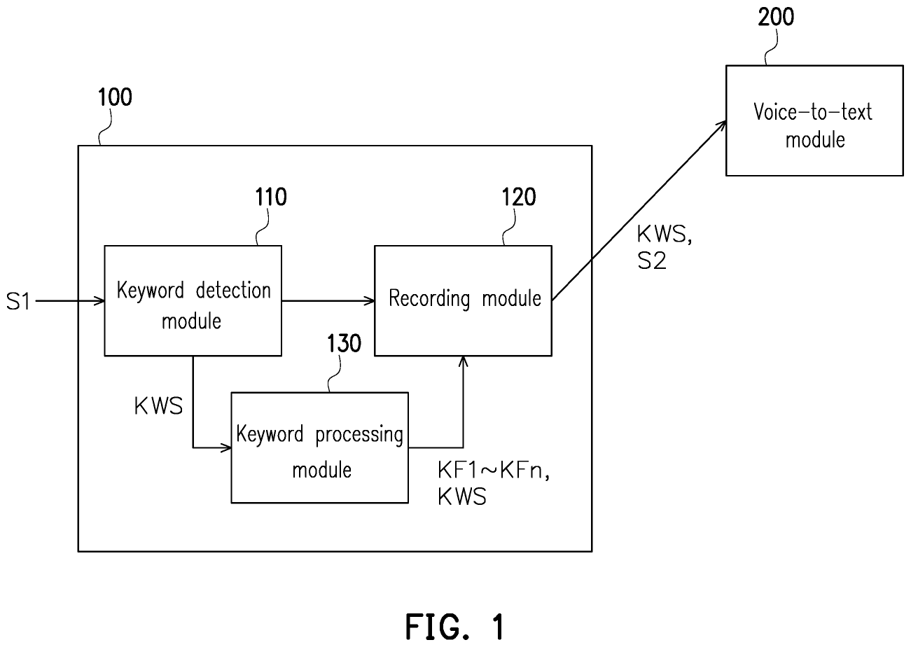

Referring to FIG. 1, FIG. 1 is a schematic view of a voice detection device according to an embodiment of the present invention. In the present embodiment, the voice detection device 100 includes a keyword detection module 110, a recording module 120 and a keyword processing module 130. The voice detection device 100 is an a dedicated server, such as a desktop computer, a notebook computer, a tablet personal computer (PC), an ultra mobile personal computer (UMPC), a personal digital assistant (PDA), a smart phone, a mobile phone or a play station portable (PSP) device. The recording module 120 is coupled to the keyword detection module 110. The keyword detection module 110 is used for receiving an audio signal provided by a user, and detecting whether the audio signal has a keyword or not, in other words, the keyword detection module 110 is used for detecting whether the speech of the user has the keyword or not. In the present embodiment, the keyword detection module 110 may be an application program used for detecting whether the audio signal has the keyword or not or an operational circuit capable of achieving the same function. The keyword detection module 110 receives the speech of the user through a microphone device built in the voice detection device 100 or an external microphone device and detects whether the audio signal provided by the user has the keyword or not. The recording module 120 is used for recording the audio signal provided by the user. In the present embodiment, the recording module 120 may be a recording application program built in the voice detection device 100, and the recording module 120 may receive the audio signal provided by the user through the microphone device built in the voice detection device 100 or the external microphone device. The keyword processing module 130 is coupled to the keyword detection module 110 and the recording module 120. The keyword processing module 130 is used for receiving a keyword audio signal KWS detected by the keyword detection module 110, and obtaining a plurality of keyword features KF1-KFn in the keyword audio signal KWS. In the present embodiment, the keyword processing module 130 may be an application program obtaining the features of the audio signal, or an operational circuit capable of achieving the same function. In the present embodiment, the voice detection device 100 may transmit the audio signal recorded by the recording module 120 to a voice-to-text module 200 in a wired communication manner or a wireless communication manner. The wireless communication manner may be signal transmission of a global system for mobile communication (GSM), a personal handy-phone system (PHS), a code division multiple access (CDMA) system, a wideband code division multiple access (WCDMA) system, a long term evolution (LTE) system, a worldwide interoperability for microwave access (WiMAX) system, a wireless fidelity (Wi-Fi) system or Bluetooth. In some embodiments, the voice-to-text module 200 may be arranged in the voice detection device 100.

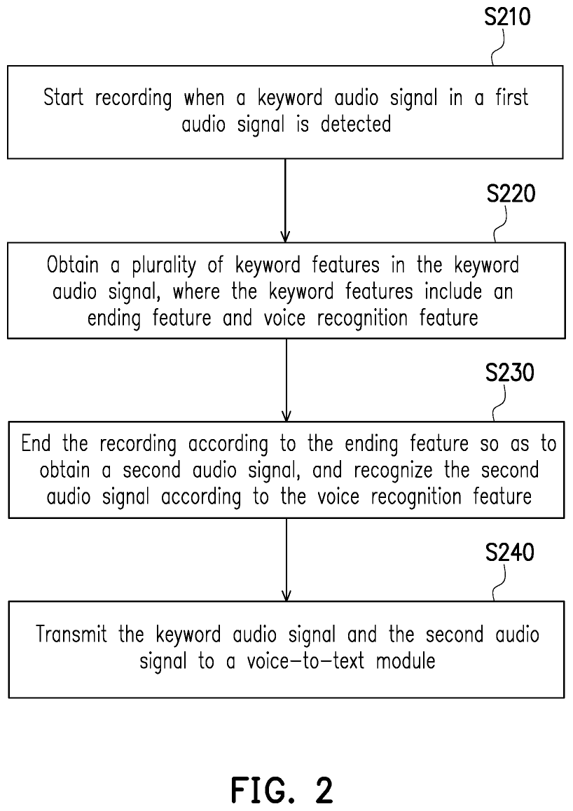

Referring to FIG. 1 and FIG. 2 at the same time, FIG. 2 is a flow chart of a voice detection method according to an embodiment of the present invention. Firstly, as described in step S210 of the present embodiment: starting recording when the keyword audio signal KWS in a first audio signal S1 is detected. The keyword detection module 110 receives the audio signal provided by the user and detects the keyword audio signal KWS in the audio signal, so that the audio signal provided by the user is distinguished as the first audio signal S1 and a second audio signal S2, the first audio signal S1 has the keyword audio signal KWS, and the second audio signal S2 is an audio signal obtained when recording starts after the first audio signal S1.

When the keyword detection module 110 detects the keyword audio signal KWS in the first audio signal S1, the recording module 120 is instructed to start recording. In step S210, the recording module 120 starts recording after the keyword detection module 110 detects the keyword audio signal KWS in the first audio signal S1. The recording module 120 records the audio signal after the keyword audio signal KWS is detected. For example, the user speaks an audio signal of a voice signal “Hi! Jarvis, what is the temperature today” to the voice detection device 100, an audio signal corresponding to a keyword “Jarvis” is a preset keyword audio signal KWS of the voice detection device 100. That is, an audio signal corresponding to “Hi! Jarvis” is the first audio signal S1, and an audio signal corresponding to “what is the temperature today” is the second audio signal S2. The keyword detection module 110 detects the audio signal corresponding to the keyword “Jarvis” in the first audio signal S1, and instructs the recording module 120 to start recording.

In some embodiments, the keyword detection module 110 instructs the recording module 120 to start recording only when keyword detection module 110 detects that a volume corresponding to the keyword audio signal KWS is greater than or equal to a preset value. Whereas, the keyword detection module 110 does not instruct the recording module 120 to start recording when keyword detection module 110 detects that the volume corresponding to the keyword audio signal KWS is less than the preset value.

As described in step S220: obtaining a plurality of keyword features KF1-KFn in the keyword audio signal KWS, wherein the plurality of keyword features includes an ending feature and a voice recognition feature. The keyword processing module 130 is used for obtaining the plurality of keyword features KF1-KFn in the keyword audio signal KWS in step S220. In the present embodiment, the keyword features KF1-KFn are audio features captured from the keyword audio signal KWS. In the present embodiment, the keyword features KF1-KFn include the ending feature and the voice recognition feature.

In step S220, the keyword detection module 110 transmits the keyword audio signal KWS to the keyword processing module 130, and the keyword processing module 130 performs keyword processing on the keyword audio signal KWS to obtain the plurality of keyword features KF1-KFn in the keyword audio signal KWS. The keyword processing used in the present embodiment on the keyword features may be, for example, at least one of sampling frequency comparison processing, short term power processing, zero-crossing processing, processing of mel scaled frequencies, cepstal coefficient processing, pitch processing, voice activity detection, fast Fourier transform or beamforming. The keyword processing module 130 further obtains the ending feature and the voice recognition feature in the keyword features KF1-KFn according to keyword processing. For example, the keyword processing module 130 can obtain at least one of voice features of intonation, volume change, volume and speed when the user ends providing the keyword audio signal KWS by means of the above keyword processing, so as to generate the ending feature. The keyword processing module 130 can obtain at least one of voiceprint features of intonation, frequency, volume change and speed when the user provides the keyword audio signal KWS by means of the above keyword processing, so as to generate the voice recognition feature.

In other embodiments, the keyword processing module 130 may only obtain the ending feature in the keyword features KF1-KFn according to keyword processing, and not obtain the voice recognition feature in the step S220.

As described in step S230: ending the recording according to the ending feature so as to obtain the second audio signal S2, and recognizing the second audio signal S2 according to the voice recognition feature. The keyword processing module 130 transmits the keyword audio signal KWS and the plurality of keyword features KF1-KFn to the recording module 120. In step S230, the recording module 120 ends the recording according to the ending feature in the plurality of keyword features KF1-KFn so as to obtain the second audio signal S2 between recording starting and recording ending. Continuing the above example, the keyword processing module 130 can obtain the ending feature and the voice recognition feature of the plurality of keyword features KF1-KFn in the keyword audio signal KWS corresponding to “Jarvis” in step S220. The recording module 120 can end the recording according to the ending feature in the plurality of keyword features KF1-KFn and obtain the second audio signal S2 corresponding to “what is the temperature today”. In addition, the recording module 120 also recognizes the second audio signal S2 according to the voice recognition feature in the plurality of keyword features KF1-KFn, so as to judge whether the second audio signal S2 and the first audio signal S1 are provided by the same user or not.

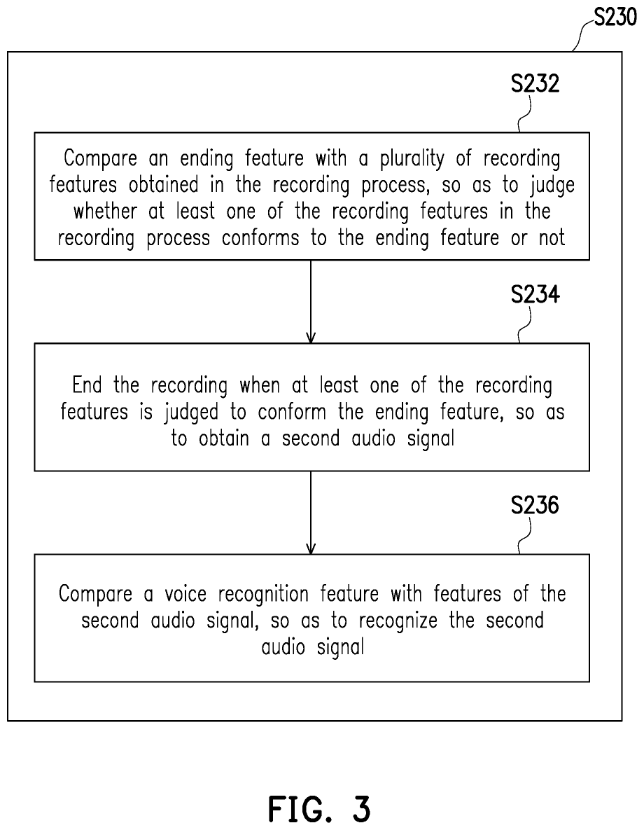

Implementation details of voice detection are further illustrated, referring to FIG. 1 and FIG. 3 at the same time, and FIG. 3 is a flow chart of the voice detection method according to step S230 of FIG. 2. In the present embodiment, step S230 further includes steps S232-S236. As described in step S232: comparing the ending feature with a plurality of recording features obtained in the recording process, so as to judge whether at least one of the recording features in the recording process conforms to the ending feature or not. The recording module 120 obtains the recording features in the recording process and compares the ending feature with the recording features, so as to judge whether the recording module 120 has the recording feature conforming to the ending feature or not in the recording processing. The recording module 120 can, for example, compare the ending feature with the plurality of features of the second audio signal S2 through dynamic time warping processing. In addition, the recording module 120 may also judge whether recording has ended or not by means of at least one of pop noise check and silence check.

Next, in step S234: end the recording when at least one of the recording features is judged to conform the ending feature, so as to obtain a second audio signal S2. The recording module 120 ends the recording when keyword detection module 110 judges that the recording features obtained in the recording process have at least one recording feature conforming to the ending feature in step S234. After ending the recording, the recording module 120 uses the audio signal recorded in the recording process as the second audio signal S2. Otherwise, the recording module 120 continues recording if keyword detection module 110 is judged that there is no recording feature conforming to the ending feature or is not found that the recording has ended by means of at least one of pop noise check and silence check.

For example, in the process that the user provides the first audio signal S1 to the voice detection device 100, the keyword audio signal KWS corresponding to the keyword “Jarvis” is also provided. That is, the keyword audio signal KWS corresponding to the keyword “Jarvis” is contained in the first audio signal S1. The keyword processing module 130 can obtain the ending feature that the user ends providing the keyword audio signal KWS corresponding to the keyword “Jarvis” through the keyword audio signal KWS. The ending feature may be, for example, a volume changing tendency when the user finishes providing the keyword audio signal KWS. The recording module 120 generates the recording feature corresponding to “what is the temperature today” in the process of recording the audio signal corresponding to “what is the temperature today” in step S232. The recording module 120 compares the ending feature with the recording feature. When the recording module 120 judges that the recording feature has the conforming volume changing tendency when the user finishes providing the keyword audio signal KWS, for example, when the recording module 120 judges that a feature of an audio signal corresponding to “today” conforms to the same ending feature of the keyword audio signal KWS corresponding to the keyword “Jarvis”, the recording module 120 judges that this time point is an ending time point of the second audio signal S2 (step S234).

In step S236: comparing the voice recognition feature with features of the second audio signal S2, so as to recognize the second audio signal S2. The recording module 120 compares the plurality of features of the second audio signal S2 according to the voice recognition feature after the second audio signal S2 so as to recognize the second audio signal S2. The plurality of features of the second audio signal S2 may be obtained by at least one of sampling frequency comparing processing, short term power processing, zero-crossing processing, processing of mel scaled frequencies, cepstal coefficient processing, pitch processing, voice activity detection, fast Fourier transform or beamforming. After obtaining the plurality of features of the second audio signal S2, the recording module 120 may compare the voice recognition feature with the plurality of features of the second audio signal S2 in step S236 by means of, for example, dynamic time warping (DTW) processing, so as to recognize the second audio signal S2.

When the recording module 120 judges that at least part of the features of the second audio signal S2 conforms to the voice recognition feature, the recording module 120 judges that the first audio signal S1 and the second audio signal S2 are provided by the same user, and judges that the second audio signal S2 includes an effective voice message. That is, the recording module 120 can judge whether the second audio signal S2 includes the effective voice message or not by judging whether at least one feature of intonation, frequency, volume change and a speech speed of the keyword audio signal KWS conforms to at least one feature of intonation, frequency, volume change and speech speed of the second audio signal S2 or not. It may be seen that the voice recognition feature can enhance the recognition capacity of the voice instruction.

In other embodiments, the keyword processing module 130 may only obtain the ending feature in the keyword features KF1-KFn according to keyword processing, and not obtain the voice recognition feature in the keyword features KF1-KFn. In the case where the voice recognition feature is not obtained, the recording module 120 does not enter step S236 to recognize the second audio signal S2.

Referring the FIG. 1 and FIG. 2 again, in step S240: transmitting the keyword audio signal KWS and the second audio signal S2 to the voice-to-text module 200. The voice-to-text module 200 can convert the voice message corresponding to the second audio signal S2 into a text message. For example, the voice-to-text module 200 converts the voice message of the second audio signal S2 containing “what is the temperature today” into the text message of “what is the temperature today”. The voice detection device 100 can also provide the keyword audio signal KWS including the plurality of keyword features to a database of the voice-to-text module 200. In the present embodiment, the voice-to-text module 100 may be a server arranged outside the voice detection device 100. The plurality of keyword features KF1-KFn provided to the database of the voice-to-text module 200 are used for enhancing the voice recognition capacity of the voice-to-text module 200.

In some embodiments, the voice detection device 100 may further provide the plurality of features of the second audio signal S2 including the effective voice message to the database of the voice-to-text module 200. The plurality of features of the second audio signal S2 including the effective voice message can also be used for enhancing the voice recognition capacity of the voice-to-text module 200.

In some embodiments, the features of the second audio signal S2 obtained by the recording module 120 do not conform to the voice recognition feature, the recording module 120 judges that the first audio signal S1 and the second audio signal S2 are not provided by the same user, and judges that the second audio signal S2 does not include the effective voice message. The recording module 120 does not transmit the second audio signal S2 that does not include the effective voice message to the voice-to-text module 200.

Based on the above, the voice detection method of the present invention obtains the plurality of keyword features in the keyword audio signal, ends the recording according to the plurality of keyword features so as to obtain the second audio signal between recording starting and recording ending, and transmits the keyword and the second audio signal to the voice-to-text module, so as to enhance the recognition capacity of the voice recognition.

Although the present invention has been disclosed with the embodiments as above, the embodiments are not intend to limit the present invention, any person of ordinary skill in the art may make little alteration and modification without departing from the spirit and the scope of the present invention, and thus the protection scope of the present invention is defined by the scope of the appended claims.

What is claimed is:

1. A voice detection method, suitable for providing a detected voice signal to a voice-to-text module, comprising:
starting recording when a keyword audio signal in a first audio signal is detected;
obtaining a plurality of keyword features in the keyword audio signal, wherein the keyword features comprise an ending feature;
ending the recording according to the ending feature so as to obtain a second audio signal; and
transmitting the keyword audio signal and the second audio signal to the voice-to-text module.

2. The voice detection method according to claim 1, wherein the step of starting recording when the keyword audio signal in the first audio signal is detected comprises:
starting recording when a volume of the keyword audio signal is detected to be greater than or equal to a preset value.

3. The voice detection method according to claim 1, wherein the step of obtaining the keyword features in the keyword audio signal, wherein the keyword features comprise the ending feature, comprises:
performing keyword processing on the keyword audio signal so as to obtain the keyword features in the keyword audio signal.

4. The voice detection method according to claim 3, the keyword processing is at least one of sampling frequency comparison processing, short term power processing, zero-crossing processing, processing of mel scaled frequencies, cepstal coefficient processing, pitch processing, voice activity detection, fast Fourier transform or beamforming.

5. The voice detection method according to claim 1, further comprising:
obtaining a voice recognition feature in the keyword features; and
comparing the voice recognition feature with features of the second audio signal, so as to recognize the second audio signal.

6. The voice detection method according to claim 1, wherein the step of ending the recording according to the ending feature so as to obtain the second audio signal comprises:
obtaining a plurality of recording features in the recording process;
comparing the ending feature with the recording features, so as to judge whether at least one of the recording features in the recording process conforms to the ending feature or not; and
ending the recording when at least one of the recording features is judged to conform the ending feature.

7. The voice detection method according to claim 1, wherein the step of transmitting the keyword audio signal and the second audio signal to the voice-to-text module comprises:
converting a voice message corresponding to the second audio signal to a text message; and
providing the keyword features into a database of the voice-to-text module, wherein the keyword features are used for enhancing voice recognition.

8. A voice detection device, suitable for performing voice detection on an audio signal and also suitable for being in communication with a voice-to-text module, comprising:
a keyword detection module, used for detecting whether a first audio signal comprises a keyword audio signal or not.
a keyword processing module, coupled to the keyword detection module, and used for obtaining a plurality of keyword features in the keyword audio signal, wherein the keyword features comprise an ending feature, and transmitting the keyword audio signal and the keyword features; and
a recording module, coupled to the keyword detection module and the keyword processing module, wherein when the keyword detection module detects the keyword audio signal in the first audio signal, the recording module starts recording, and the recording module receives the keyword audio signal and the keyword features, ends the recording according to the ending feature so as to obtain a second audio signal, and transmits the keyword audio signal and the second audio signal to the voice-to-text module.

9. The voice detection device according to claim 8, wherein the keyword detection module instructs the recording module to start recording when detecting that a volume corresponding to the keyword audio signal is greater than or equal to a preset value.

10. The voice detection device according to claim 8, wherein the keyword processing module performs keyword processing on the keyword audio signal so as to obtain the keyword features in the keyword audio signal.

11. The voice detection device according to claim 10, wherein the keyword processing is at least one of sampling frequency comparison processing, short term power processing, zero-crossing processing, processing of mel scaled frequencies, cepstal coefficient processing, pitch processing, voice activity detection, fast Fourier transform or beamforming.

12. The voice detection device according to claim 8, wherein
the keyword processing module is further used for obtaining a voice recognition feature of the keyword features; and
the recording module is further used for comparing the voice recognition feature with features of the second audio signal, so as to recognize the second audio signal.

13. The voice detection device according to claim 8, wherein the recording module is further used for:
comparing the ending feature with a plurality of recording features obtained in the recording process, so as to judge whether at least one of the recording features conforms to the ending feature or not; and
ending the recording when at least one of the recording features is judged to conform the ending feature.

14. The voice detection device according to claim 8, wherein the voice-to-text module is further used for converting a voice message corresponding to the second audio signal to a text message, and providing the keyword features into a database of the voice-to-text module, wherein the keyword features are used for enhancing voice recognition.
